(19) United States
(12) Patent Application Publication
(10) Pub. No.: US 2020/0301676 A1
(43) Pub. Date: Sep. 24, 2020

(54) Framework for GPU Code Generation and Debugging

(71) Applicant: ThunderTech Inc., Englewood, CO (US)

(72) Inventors: Alan Rock, Morrison, CO (US); Longpeng Zhang, Englewood, CO (US)

(21) Appl. No.: 16/404,445

(22) Filed: May 6, 2019

Related U.S. Application Data
(60) Provisional application No. 62/820,680, filed on Mar. 19, 2019.

(51) Int. Cl. G06F 8/30; G06F 11/36; G06T 1/20

(52) U.S. Cl. CPC G06F 8/30; G06T 1/20; G06F 11/362

(57) ABSTRACT

Novel tools and techniques for GPU code generation and debugging are provided. A system includes a GPU, graphics memory coupled to the graphics processing unit, a processor; and non-transitory computer readable media comprising instructions executable by the processor to define, via an asset file, one or more shader functions of a GPU programming language extend the first programming language to include the one or more shader functions defined in the asset file, instantiate a first programming language based on the one or more asset files, receive, via an interface of the code editor, code written in the first programming language for a first program, and generate a GPU executable binary of the first program.

### CROSS REFERENCE TO RELATED APPLICATIONS

This application claims priority to U.S. Provisional Patent Application Ser. No. 62/820,680, filed Mar. 19, 2019 by Alan Rock et al. (attorney docket no. 1127.02PR), entitled “Framework for GPU Code Generation and Debugging,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to the field of programming graphics processing units (GPU), and more particularly to a framework for GPU code generation, development, and debugging.

### BACKGROUND

GPUs are traditionally used to handle computations for computer graphics, to rapidly generate images to be output to a frame buffer. The inherently parallel structure of GPUs allows GPUs to more efficiently perform parallel computing than central processing units. As GPUs develop to become faster, general purpose programming on graphics processing units (GPGPU) has become increasingly common, leveraging the parallel compute capabilities of GPUs to perform computations in applications traditionally handled by the CPU.

GPU programming languages have traditionally been analogous to low level programming languages and provide limited abstraction in terms of functions and commands. Thus, GPGPU programming and debugging has typically been limited to small programs, and relatively simple functions and routines. Often in GPGPU, small programs or subroutines are passed from a CPU to a GPU for execution, and the result passed back to the CPU for further processing. Accordingly, debugging GPU code is often limited in scope, and existing debugging tools available for CPU code are generally incompatible.

Accordingly, tools and techniques are provided for providing a high-level framework for GPU code generation and debugging.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram of a framework for systems and methods of GPU code generation and debugging, in accordance with various embodiments;

FIG. 2 is a flow diagram of a method for GPU code generation and debugging, in accordance with various embodiments;

FIG. 3 is a schematic diagram of a code generation editor, in accordance with various embodiments;

FIG. 4 is a schematic diagram of a GPGPU workflow, in accordance with various embodiments;

FIG. 5 is a schematic block diagram of a computer system for implementing framework for GPU code generation and debugging, in accordance with various embodiments.

### DETAILED DESCRIPTION OF CERTAIN EMBODIMENTS

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In one aspect, a system includes a graphics processing unit (GPU), graphics memory coupled to the graphics processing unit, a processor, and non-transitory computer readable media comprising instructions executable by the processor to perform various functions. The instructions may be executable by the processor to define, via an asset file, one or more shader functions of a GPU programming language in source code written in a central processing unit (CPU) programming language. The instructions may further be executable to extend the first programming language to include the one or more shader functions defined in the asset file, and instantiate a first programming language, in a code editor, based on the one or more asset files, wherein the first programming language includes the CPU programming language and the one or more shader functions. The instructions may further be executed to receive, via an interface of the code editor, code written in the first programming language for a first program; and generate, via the code editor, a GPU executable binary of the first program.

In another aspect, an apparatus includes a processor, and non-transitory computer readable media comprising instructions executable by the processor to define, via an asset file, one or more shader functions of a GPU programming language in source code written in a central processing unit (CPU) programming language. The instructions may further be executable to cause the processor to extend the first programming language to include the one or more shader functions defined in the asset file, and instantiate a first programming language, in a code editor, based on the one or more asset files, wherein the first programming language includes the CPU programming language and the one or more shader functions. The instructions may further be executed by the processor to receive, via an interface of the code editor, code written in the first programming language for a first program, and generate, via the code editor, a GPU executable binary of the first program.

In a further aspect, a method includes defining, via an asset file, one or more shader functions of a GPU programming language in source code written in a central processing unit (CPU) programming language, and extending, via a computer system, the first programming language to include the one or more shader functions defined in the asset file. The method continues by instantiating, via the computer system, a first programming language based on the one or more asset files, wherein the first programming language includes the CPU programming language and the one or more shader functions. The method further includes receiving, via the computer system, code written in the first programming language for a first program, and generating, via the computer system, a GPU executable binary of the first program.

Various modifications and additions can be made to the embodiments discussed without departing from the scope of the invention. For example, while the embodiments described above refer to specific features, the scope of this invention also includes embodiments having different combination of features and embodiments that do not include all the above described features.

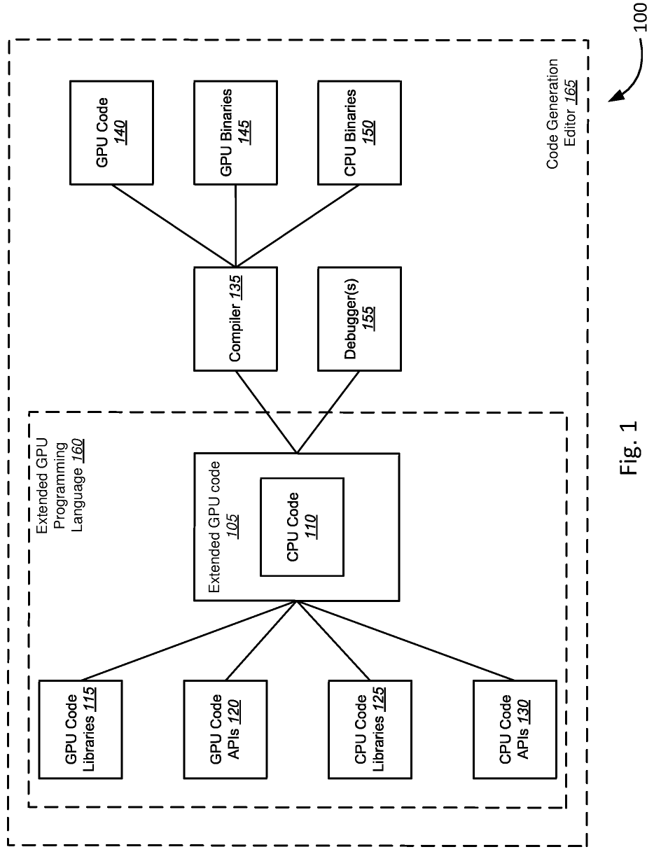

FIG. 1 is a schematic diagram of a framework 100 for implementing systems and methods for GPU code generation and debugging, in accordance with various embodiments. The framework 100 may be implemented in a code generation editor 165 for an extended GPU programming language 160. The extended GPU programming language 160 may support extended GPU code 105, and CPU code 110, which may in turn include GPU code libraries 115, GPU code application programming interfaces (API) 120, CPU code libraries 125, and CPU code APIs 130. The code generation editor 165 may further include a compiler 135 of the extended GPU programming language 160, and one or more debuggers 155. The compiler 135 may produce, from the extended GPU code 105, GPU code 140 in one or more GPU programming languages, one or more respectively GPU binaries 145, and CPU binaries 150. It should be noted that the various components of the framework 100 are schematically illustrated in FIG. 1, and that modifications to the framework 100 may be possible in accordance with various embodiments.

In various embodiments, the code generation editor 165 may support programming in an extended GPU programming language 160. Thus, extended GPU code 105 may be written in the extended GPU programming language 160. In the following description, the extended GPU programming language 160 may be referred to interchangeably as “G #,” and the code generation editor as the “G # editor,” for ease of reference. The extended GPU code 105 (e.g., G # code) may be built upon CPU code 110, written using a core CPU programming language. Thus, in some embodiments, the CPU code 110 may include CPU-executable code written in a respective CPU programming language, as known to those in the art. In some embodiments, CPU programming languages suitable for use as a core CPU language may include, without limitation, C, C++, C #, Python, or other suitable languages.

Thus, in various embodiments, the extended GPU programming language may be based on an underlying CPU programming language that has been extended to include GPU programming functions, shaders, kernels, routines and subroutines, and other features of respective GPU programming languages within an existing CPU programming language framework. For example, in some embodiments, the core CPU programming language may be a high-level programming language. In one example, the core CPU programming language may be the C # programming language.

Continuing with the foregoing example, the extended GPU programming language 160 may be an extension of C # that combines C # with one or more GPU programming languages. The one or more GPU programming languages may include, without limitation, High-Level Shading Language (HLSL), OpenGL Shading Language (GLSL), CUDA, C for graphics (Cg), Open Computing Language (OpenCL), DirectCompute, and ShaderLab. Thus, in various embodiments, extended GPU programming language 160 may modify C # coding style and rules to conform with HLSL, and modify HLSL to conform with C #. Similar modifications may be made to C # conventions to accommodate each of the one or more GPU programming languages.

There are some differences between G # and HLSL/Cg. Any differences can be reconciled using inline compiler directives, but recommended practice is to minimize the use of compiler directives. G # significantly simplifies HLSL, and thus is easier to learn and use.

The framework 100 (referred to interchangeably as the “G # framework”) may include a code generation editor 165 that is integrated into an underlying software engine. For example, in some embodiments, the G # framework may be integrated into a game engine, such as, without limitation, the Unity game engine. In such an example, the Unity game engine may be relied upon to generate all the code and Unity GameObjects, and to set all the properties required for GPU programming. The G # framework 100 may, in further embodiments, be integrated into the Visual Studio integrated development environment (IDE) for code editing and debugging. Accordingly, in various embodiments, G # code 105 may be configured to be compatible with existing debugging tools traditionally limited to CPU code.

Thus, to make accessible the various files and functions, the extended GPU programming language 160 may be defined in a respective engine via one or more asset files, which may include, without limitation, shader include files (e.g., .cginc, .glslinc, etc.) and/or C # source code files (e.g., .cs). Shader include files may include one or more of compute shaders and material shaders to define the G # framework 100. The shader include files may, in various embodiments, modify the structure of HLSL and ShaderLab using #define macros to conform to extended GPU programming language 160 conventions.

The code generation editor 165 may generate several different files based on the shader include files. For example, a .cginc shader include file may include code used by both the .compute and .shader files. In various embodiments, a .cginc shader include file may generate constants and enumerate on values. If a constant or enumeration is changed in the corresponding .cs file, corresponding changes must be made to the .cginc file. A .compute file includes the kernel functions. If a kernel function is added, renamed, or deleted in the .cs file, corresponding changes must be made to the .compute file. A .shader file includes the shader settings, such as blending, culling, targeting, etc. If the vert or frag function names are changed in the .cs file, corresponding changes must be made to the .shader file.

The .cs file, accordingly, may include the C # source code for various assets, functions, routines, computer kernels, and the like. Accordingly, the .cs file may define various GPU code libraries 115, GPU code APIs 120, as well as CPU code libraries 125 and CPU code APIs 130 in C # source code. For example, in some embodiments, the .cs file may include compute shader kernel functions, and shader vertex and fragment functions in C # source code. Conditional compiler directives (# if . . . # endif) may be configured to merge HLSL into the extended GPU programming language 160. In some embodiments, compiler directives are configured to isolate the C # code section, the compute shader code section, and the material shader code section, for kernel function parameter declarations, and the vertex/fragment FragInput struct.

In one example, the C # source code file (e.g., .cs file) may include links to external objects, such as materials, cameras, and other prefabricated code or objects, such as a Unity Prefab. The .cs file may further include enumerations, and definitions for fields corresponding to the GPU Fields that appear in the inspector, with tooltips, default values, and ranges. A ValuesChanged property is defined to detect when a value is changed in the inspector, or by the program. The .cs file may further define update speeds when the program is running in the editor. The G property is defined as a wrapper to accessing the GPU field buffer. On GUI is run every update when running in editor mode. This is where to handle mouse and keyboard events when running in the editor.

The .cs file may further define CPU actions as they appear in, for example, the Inspector in Unity. LateUpdate detects button clicks on CPU actions in the Inspector, and runs the corresponding action. LateUpdate also detects GPU Field changes in the Inspector. Next, the .cs file may define CPU action functions. For example, onRenderObject( ) may call the material shader. Debugging the material shader can also be initiated from here. Awake( ) may initialize other variables. Update( ) includes code run when the program is not executing in the editor.

The .cs file may further include GPU kernel function wrappers. These occasionally need code modification for special cases. GPU kernel function wrappers may be also be configured to allow debugging of the kernel functions. For example, in some embodiments, changing the defined GPU kernel function may be specified to run on the CPU for debugging purposes.

The .cs file may further include code used by C #, the compute shader, and the material shader. The .cs file may include a struct with the GPU fields, structs, and GPU buffers. The compute shader code may include code that is excluded from the material shader, defining the GPU kernel functions. The .cs file may further include material shader code, so is excluded in the compute shader.

Accordingly, in various embodiments, the G # framework 100 may be integrated into the Unity game engine for full CPU and GPU development for design, implementation, and debugging. The extended GPU programming language 160 may be configured to merge HLSL, GLSL, CG, CUDA, and ShaderLab into C #, combining all aspects of GPU development into a single language. The code generation editor 165 may be configured to provide automatic code generation, so that all classes, objects, and libraries can be generated and combined with a fully serialized user interface at a single mouse click. Debugger 155 of the framework 100 may include all existing development and debugging tools provided, for example, by Visual Studio or other IDEs can be used with G #, with or without additional DLLs or plugins. Full debugging capabilities are available for both material shaders and compute shaders (e.g., GPGPU).

The G # framework 100 provides libraries, for example, GPU code libraries 115 and GPU code APIs, CPU code libraries 125 and CPU code APIs 130, for project management, random numbers, inter-process communication, cubic splines, digital signal processing and display, volumetric rendering (superior to marching cubes), bit-buffers (superior to append buffers), VR/AR video processing, and allows the programmer to extend and expand existing libraries.

The debugger 155 may be configured to provide full GPU debugging, and the compiler 135 may be configured to allow porting of large portions of code from the CPU to the GPU. For example, the compiler 135 may be configured to compile respective code written in the extended GPU programming language 160, such as the extended GPU code 105, into respective GPU code 140 written in respective GPU programming languages, GPU binaries 145, and/or CPU binaries 150. Thus, by porting more of the code for execution on the GPU, radical speed increases in program execution may be achieved. In some examples, direct execution of code on the GPU may reduce CPU/GPU memory transfers. For example, reading in a large LIDAR file of ASCII point data required 3 minutes on the CPU. Utilizing the extended GPU programming language 160, and corresponding GPU binary 145 output by the compiler 135, the read operation was reduced to 4 seconds, most of which was reading the file from the hard drive and sending the text to the GPU.

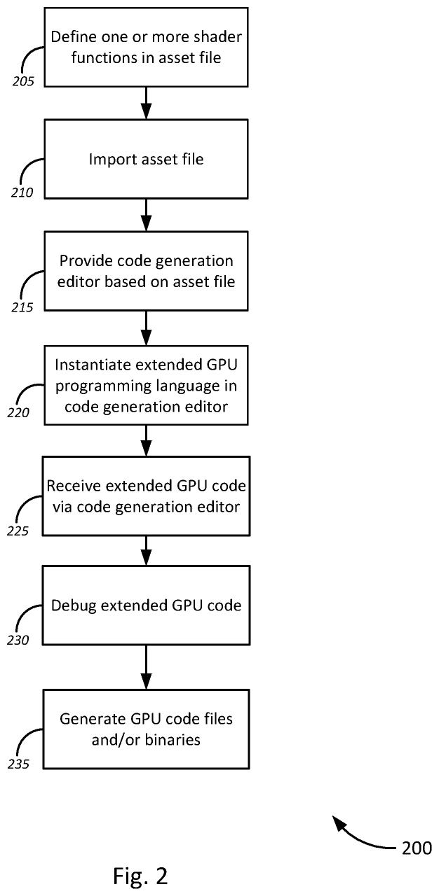

FIG. 2 is flow diagram of a method 200 for GPU code generation and debugging, according to various embodiments. The method 200 begins, at block 205, by defining one or more shader functions in an asset file. As previously described, in various embodiments, one or more shader functions may be defined in compute shader files, which may include compute kernel functions, and material shader files, which may include vertex and fragment functions, and other shader settings. A corresponding source code file, written in a CPU executable language, may define the one or more shader functions in each of the shader files in the CPU executable language. As previously discussed, this file may be a C # source code file (e.g., .cs file).

In various embodiments, the asset file may be modifiable by a user to include additional shader functions or to modify the behavior or characteristics of existing shader functions. Accordingly, in some embodiments, when a change is made to any of the compute shader files and/or material shader files, a corresponding change is made to the source code file written in the CPU executable language. For example, respective changes to a .compute or .shader file must be made to the corresponding .cs file. Similarly, any changes to shader functions in the source code file (.cs file) must be made to the respective .compute or .shader file.

The method 200 continues, at block 210, by importing the asset file into a development environment. In various embodiments, the asset file may be imported into a development environment, such as an IDE. As previously described, examples may include, without limitation, Microsoft Visual Studio IDE, or the integrated IDE within a game engine, such as the Unity game engine.

The method 200 continues, at block 215, by providing a code generation editor based on the asset file. Thus, at block 220, the extended GPU programming language may be instantiated within the code generation editor, based on the asset file. Accordingly, the extended GPU programming language may include the underlying functions, and the rules and conventions of a CPU programming language, such as C # used in the examples above. The underlying CPU programming language may then be modified to be merged with the features and functions, such as the one or more shader functions, of one or more GPU programming languages, based on the asset file through the code generation editor.

The method 200 may further include, at block 225, receiving extended GPU code via the code generation editor. At block 235, the method 200 continues by debugging the extended GPU code. As previously described, debugging may include executing one or more of the shader functions on a CPU. Thus, by porting the one or more shader functions for execution on a CPU, code written for execution on a GPU may be debugged using existing debugging tools for CPU code. In some embodiments, debugging may include specifying, in one or more of the asset files, one or more shader functions to be executed on the CPU as opposed to a GPU. As will be apparent to those skilled in the art, the extended GPU code may be debugged in sections or as a whole. Moreover, as code and/or portions of code may be converted between CPU executable code and GPU executable code, in some embodiments, portions of code in a program may selectively be executed on a CPU for debugging, while other portions of code of the program may be executed by the GPU.

The method continues, at block 240, by generating GPU source code files and/or GPU executable binaries. In some embodiments, a compiler of the code generation editor may be configured to generate CPU executable binary instructions. The binaries may then be compiled into GPU source code. In some embodiments, the GPU source code may then further be compiled into GPU executable binaries. In further embodiments, the compiler may generate GPU executable binaries from CPU executable binary files directly. Accordingly, the code generation editor may be configured to compile extended GPU code into various files and formats as appropriate for a given application.

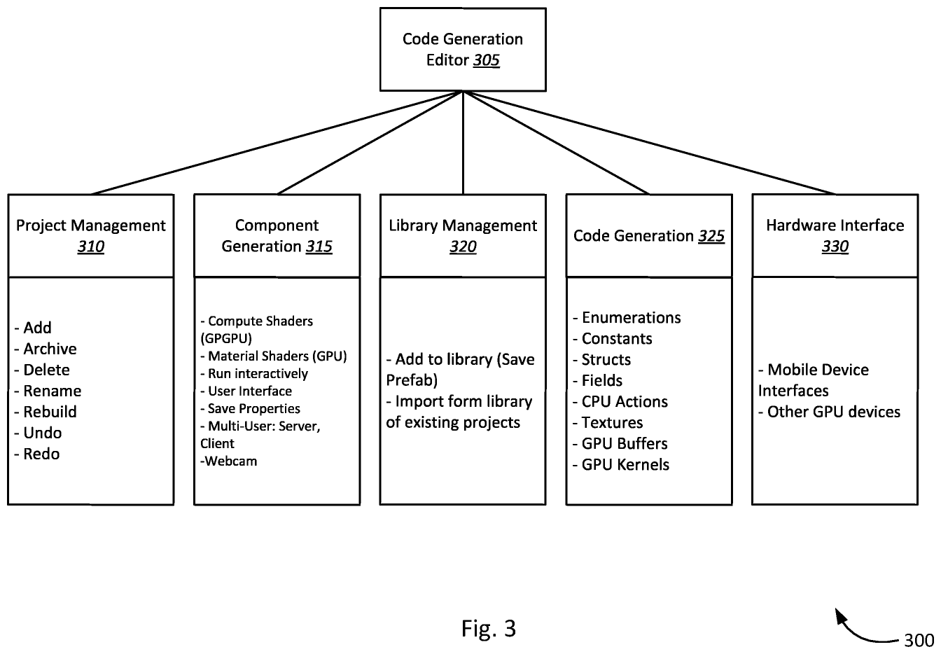

FIG. 3 is a schematic diagram of the functional framework 300 of a code generation editor 305, in accordance with various embodiments. The functional framework 300 of the code generation editor 305 include project management 310, component generation 315, library management 320, code generation 325, and hardware interface 330. In various embodiments, the code generation editor 305 may be integrated into an existing editor. In one embodiment, the existing editor may include, for example, a game engine editor such as the Unity editor. Thus, the code generation editor 305 (e.g., G # editor) may include an extended GPU programming language (e.g., G #) which has been integrated into the existing editor (e.g., Unity editor). Accordingly, the G # editor may be configured to use the existing editor, such as the Unity editor, to automate numerous tasks in the functional framework 300 via tools for project management 310, component creation 315, library management 320, code generation 325, and hardware interfaces 330.

Accordingly, in various embodiments, the code generation editor 305 may include various tools for project management 310. Project management 310 tools within the code generation editor 305 may include, without limitation, the ability add projects, archive projects, delete projects, rename projects, and rebuild projects. A project as used herein may include, for example, a group of one or more programs, assets, scenes, and other related files associated with the project, as known to those in the art. Project management tools 310 may further support undo and redo functionality. In some further embodiments, projects may further be sorted by name or by modified date and viewed as a scrollable subset or in entirety.

In various embodiments, the code generation editor 305 may further include various tools for component generation 315. Code for various project components may be included, via the code generation editor 305, at any time. Projects may run entirely on the CPU, or with additional GPGPU or GPU graphics capabilities. Continuing with the example of integration of the code generation editor 305 with the Unity editor, the code generation editor 305 and/or the extended GPU programming language may be configured to automatically generate all code files, and create required Unity GameObjects and Materials, create and set all required properties, and link together all components and libraries. User interface components may also be included in the code generation editor 305 which may be configured to automatically generate fully customizable tabs, dropdown lists, checkboxes, scrollable integer and float values, and action buttons. The code generation editor 305 may further include code configured to save and restore user interface settings and values, with automatic version control. The code generation editor 305 may further include components generation 315 tools configured to support multi-user applications. Multi-user support may include, for example, client/server models. Component generation 315 tools may further include tools for transferring video from web cameras to the GPU in a native format.

In various embodiments, the code generation editor 305 may further include tools for library management 320. For examples, libraries for the extended GPU programming language, (e.g., G # libraries) may also be accessed and managed from the code generation editor 305. Continuing with the example of Unity editor integration, projects may be saved as, for example, Unity Prefabs for efficient reuse. All prefabs may be imported from the G # library, and the extended GPU programming language framework may be configured to generate all the necessary code and required property settings. Libraries may be sorted by name or by modified date and viewed as a scrollable subset or in entirety, similar to project management 310.

The code generation editor 305 may further be configured to include tools for code generation 325. Code generation 325 tools may include tools configured to generate code from a list of enumeration, constants, structs, fields, and methods. For example, in conventional GPU software development, code must be duplicated on the CPU, the GPU, and the GPGPU, usually in different formats and languages. The programmer must be careful to duplicate any code modifications across all the platforms. In contrast, the code generation 325 tools of the code generation editor 305 may be configured to may be configured to automatically generate code in which code modifications are propagated across all platforms.

For example, enumerations are constructs supported by C #, but are not supported in GPU languages. Code generation 325 of the code generation editor 305 allows enumerations to be run on the GPU by automatically generating constants and defines with names corresponding to the enumeration in files read by the GPGPU compiler, the GPU compiler, and the CPU compiler as previously described with respect to FIG. 1.

In another example, constants are another code construct that must be duplicated across multiple platforms in different formats. The extended GPU programming language (e.g., G #) may be configured to specify several useful and common constants, as well as allowing programmers to specify custom constants. Constants that are modified in the code generation editor 305 may be automatically generated across both CPU and GPU platforms by the code generation editor 305. In a further example, “Structs,” short for structures, allow advanced data organization into elements and arrays. In various embodiments, the extended GPU programming language may be configured to support custom specification of structs with scalar and vector types of float, integer, and bool. Accordingly, in some embodiments, the code generation editor 305 may be configured to allow a user to specify custom Structs, and to automatically propagate the custom Structs across platforms. GPUs are typically limited on the number of declared fields supported. To address these limitations, the extended GPU programming language (e.g., G #) may be configured to combine all GPU fields in a single project struct. In some embodiments, fields in the code generation editor 305 (e.g., G # Editor) may be included in the GPU struct, displayed in, for example, the Unity Inspector, and/or displayed in the application user interface. Field declarations may be configured to support display names, descriptions, comments, the field type, initial values, valid ranges, display formats, English or SI units, use of scrollbars, arrays, tables, table display formats, conditions for when to show or hide the field, various language translations such as Chinese or English, and read only restrictions. As the user interface expands, in some embodiments, the code generation editor 305 may be configured to move groups of fields to additional and/or other G # projects, and to automatically import the other projects to condense and organize the UI.

In some embodiments, the code generation editor 305 may further include a section for declaring CPU actions. Thus, code generation 325 tools may include buttons in the user interface of the code generation editor 305 or the Unity Inspector that the user may click to run methods on the CPU. The CPU action code generation 325 tool may be configured to generate code/CPU methods, which may in turn allow GPU methods, known as kernels, to run on the CPU.

GPU graphics programming often incorporates several graphical textures from images or video. The code generation editor 305 may, in some embodiments, further be configured to provide a section for organizing and using 2D textures. Textures require different specification for the CPU and GPU. Thus, the code generation editor 305 may include code generation 325 that automates coding of the textures across different platforms.

GPU Buffers are arrays of scalar or vector floats or integers, or arrays of structs. In some embodiments, the code generation editor 305 may further be configured to provide code generation 325 tools that allows the programmer to specify the type, size, and dimension of all the GPU Buffers used in the project. Accordingly, the code generation 325 tools may be configured to automatically allocate, initialize, pass to both material shaders and compute shaders, and release with code for the GPU buffers.

In further embodiments, the code generation editor 305 may provide code generation 325 for specifying GPU Kernels. For example, the code generation editor 305 may allow specification of kernel names, thread sizes, and dimensions.

In various embodiments, the code generation editor 305 may further be configured with tools to support various hardware interfaces 330. For example, the code generation editor 305 may be configured to support the programming of devices with GPUs, such as, without limitation, tablets, smart phones and other mobile devices, and smart TVs. For example, in some embodiments, the code generation editor 305 may be configured to automatically establish programming and debugging of a mobile device over a wired and/or wireless interface. For example, suitable wireless interfaces may include, without limitation, a Bluetooth™, 802.11x, low power wireless, or other suitable wireless connection. Wired interfaces may include connections over universal serial bus (USB), Thunderbolt, Ethernet (cat 3, cat 5, cat 5e, cat 6), PCI or other serial connectors, or other suitable wired connection media.

The code generation editor 305 may, accordingly, be configured to generate CPU and GPU code from tables of structs, fields, and methods, thus providing programmers the ability to develop and debug complex and comprehensive programs from start to finish.

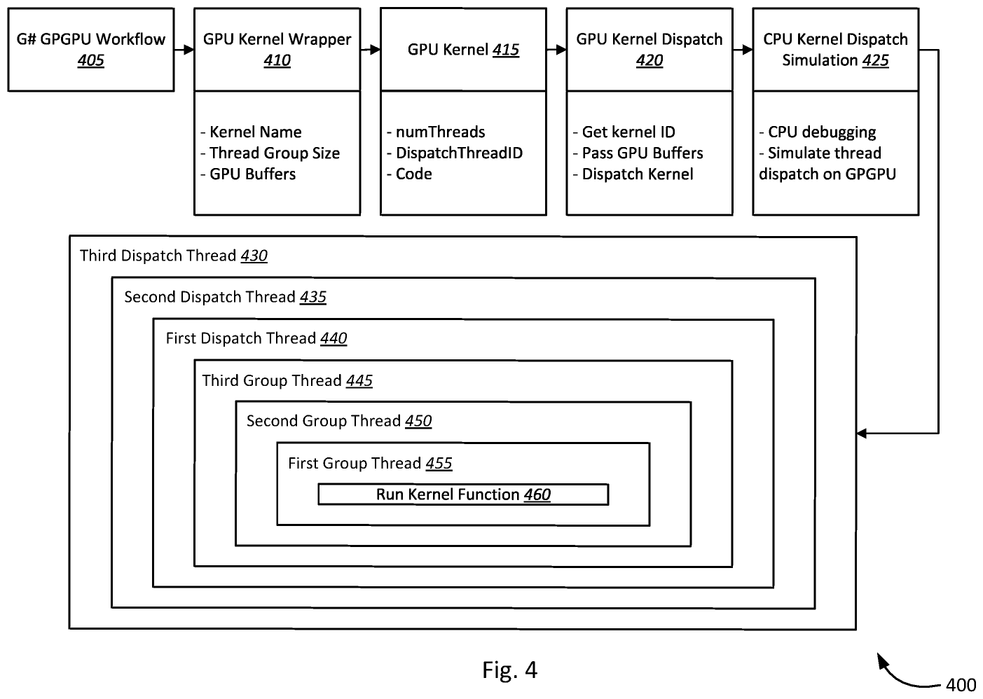

FIG. 4 is a schematic diagram of a workflow 400 within the extended GPU programming language framework, in accordance with various embodiments. Specifically, the workflow 400 schematically depicts an example of a GPGPU workflow 405 for calling a GPGPU kernel 415. Accordingly, the workflow 400 includes the G # GPGPU workflow 405, GPU kernel wrapper 410, GPU kernel 415, GPU kernel dispatch 420, and CPU kernel dispatch simulation 425.

The G # GPGPU workflow 405 may begin by generating a GPU kernel wrapper 410. In various embodiments, the code generation editor may be configured to automatically generate the GPU kernel wrapper. Generating the GPU kernel wrapper 410, in turn, calls the GPU kernel 415 with the correct name, thread size and dimension, and the GPU buffers accessed in the kernel. One example of sample code for the GPU kernel wrapper from the code generation editor may be generated as follows:

public void compress_smps_24( )
{

var g = G;
Gpu(gAdar_compress_smps_24, g.smp_mic_3, new { gAdar },

new { smps }, new { smps_24 }, new { okMics });

}

Next, the code generation editor may be configured to generate code for each GPU kernel 415. The kernel ID is stored in an integer class variable. The kernel ID is assigned automatically using reflection. In one example, the kernel ID may start with “kernel_” and end with the name of the kernel. The kernel arguments must be separated by #if-#else-#endif compiler directives. G # code may be compiled in three passes: one pass for C # on the CPU, one pass for the compute shader, and one pass for the material shader. The variable descriptor “SV_DispatchThreadID” is sent to the compute shader, but not to C # or the material shader. The G # Editor generates code for the shell, and the programmer fills in the kernel functionality. One example of sample code generated in the code generation editor may be as follows:

int kernel_gAdar_compress_smps_24;[numthreads(numthreads3,
numthreads3, numthreads3)]
void gAdar_compress_smps_24
#if gs_compute

(uint3 id : SV_DispatchThreadID)

#else

(uint3 id)

#endif

{

gAdar g = G;
if (all(id < g.smp_mic_3))
{

uint i = id_to_i1(id.xy, g.smp_mic_N), smpI = id.x,

chI = id.y, byteI = id.z, smpsI = okMics[chI] + smpI *
g.chN;

int v = smps[smpsI];
uint I = (smpI + chI * g.smpN) * 3 + byteI, vI = I / 4,
bI = I

% 4, b = getByte((uint)v, byteI, bI);

InterlockedOr(smps_24, vI, b);

}

}

In various embodiments, the GPU kernel wrapper 410 calls the GPU( ) method. This method gets the kernel ID value using reflection, then uses the ID to perform GPU kernel dispatch 420. The GPU( ) method attaches all the GPU buffers to the kernel using reflection, then runs the kernel on the GPU. One example of sample extended GPU programming code for GPU kernel dispatch 420 is as follows:

public void Gpu(KernelFunction_dispatchThreadID kernelFunction, uint3
n, params object [ ] vals)
{

string kernelName = S(“kernel_”, kernelFunction.Method.Name);
int kernel = (int)GetType( ).GetField(kernelName,

BindingFlags.Instance | BindingFlags.Public |
BindingFlags.Nonpublic).GetValue(this);

SetKernelValues(kernel, vals);
Dispatch(kernel, kernelFunction, n);

}

In various embodiments, when debugging the kernel on CPU, the extended GPU programming language, and correspondingly the debugger of the code generation editor, may be configured to perform CPU kernel dispatch simulation 425. In some embodiments, the thread structure may be simulated using a six-level nested loop. The GPU may be configured to run each thread in parallel. In contrast, the CPU kernel dispatch simulation 425 may be configured to run each call to the kernel serially on the CPU. One example of sample code for CPU kernel dispatch simulation 425 is provided as follows:

private void _Dispatch(int kernel, KernelFunction_dispatchThreadID

kernelFunction, uint x, uint y, uint z)

{
uint3 numthreads = kernelFunction.numthreads( );
uint iter = new uint3(x, y, z);
uint dispatch = iter / numthreads + ceilu((iter % numthreads) /

(float3)numthreads);

for (uint numthreads_k = 0; numthreads_k < numthreads.z;

numthreads_k++)

for (uint dispatch_k = 0; dispatch_k < dispatch.z; dispatch_k++)

for (uint dispatch_j = 0; dispatch_j < dispatch.y; dispatch_j++)

for (uint dispatch_i = 0; dispatch_i < dispatch.x;

dispatch_i++)

{
uint3 SV_GroupID = new uint3(dispatch_i, dispatch_j,

dispatch_k);

for (uint numthreads_j = 0; numthreads_j < numthreads.y;

numthreads_j++)

for (uint numthreads_i = 0; numthreads_i < numthreads.x;

numthreads_i++)

{

uint3 SV_GroupThread = new uint3(numthreads_i,

numthreads_j, numthreads_k);

uint3 SV_DispatchThread = SV_GroupID * numthreads +

SV_GroupThreadID; kernelFunction(SV_DispatchThreadID);

}

}

}

Accordingly, various kernel functions may be run in sequential fashion. For example, each kernel function 460 (e.g., thread) of each thread group of each dispatch thread may be executed in a sequential manner by the CPU. For example, the CPU may run kernel function 460 (e.g., thread) of each of the first group thread 455. The CPU may then execute each thread/kernel function of the second group thread 450, and sequentially through each thread/kernel function of the third group thread 445. In this way, each thread of each thread group of the first dispatch thread 440 may be executed. The CPU may similarly execute each kernel function of each group thread of each of the second dispatch thread 435, and finally third dispatch thread 430. Accordingly, the depicted example steps through a three dispatch thread arrangement (e.g., (1, 1, 3), (1, 3, 1), (3, 1, 1)), and three group thread arrangement (e.g., (1, 1, 3), (1, 3, 1), (3, 1, 1)). It is to be appreciated that in other embodiments, other arrangements of dispatch threads and group threads may be utilized, but the code generation editor/debugger may be configured to similarly execute each of the individual threads/kernel functions sequentially. Following the above approach allows all existing CPU debugging and code editing tools available in an IDE such as Visual studio to be used for development of GPU kernels within the code generation editor.

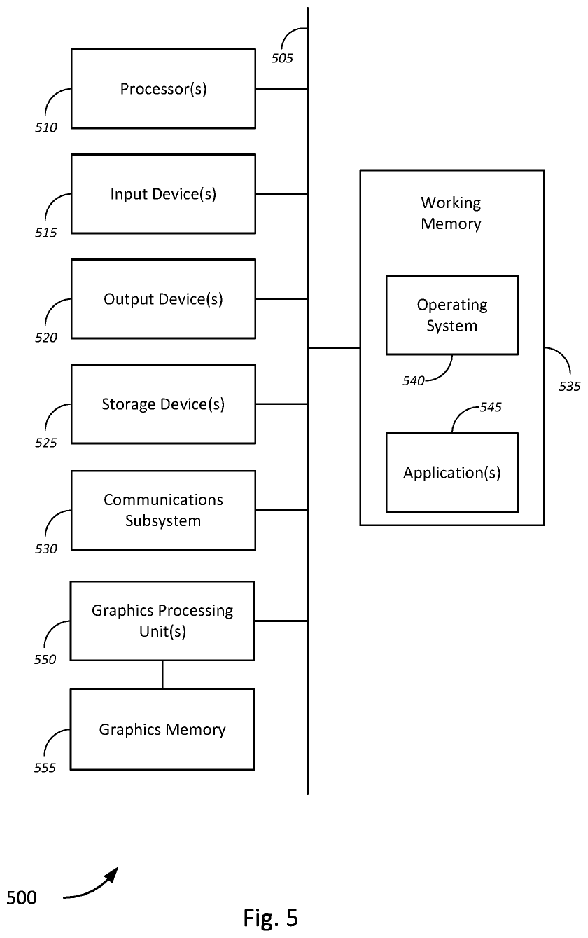

FIG. 5 is a schematic block diagram of a computer system 500 for the GPU code generation and debugging framework, in accordance with various embodiments. FIG. 5 provides a schematic illustration of one embodiment of a computer system 500, which may perform the methods provided by various other embodiments, as described herein. It should be noted that FIG. 5 only provides a generalized illustration of various components, of which one or more of each may be utilized as appropriate. FIG. 5, therefore, broadly illustrates how individual system elements may be implemented in a relatively separated or relatively more integrated manner.

The computer system 500 includes multiple hardware elements that may be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and microcontrollers); one or more input devices 515, which include, without limitation, a mouse, a keyboard, one or more sensors, and/or the like; and one or more output devices 520, which can include, without limitation, a display device, and/or the like. The computer system 500 may further include one or more graphics processing units 550 coupled to associated graphics memory 555, with may include, without limitation, graphics double data rate SDRAM (GDDR SDRAM), such as GDDR4, GDDR5, and GDDR6, or other suitable graphics memory device.

The computer system 500 may further include (and/or be in communication with) one or more storage devices 525, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 500 might also include a communications subsystem 530, which may include, without limitation, a modem, a network card (wireless or wired), an IR communication device, a wireless communication device and/or chip set (such as a Bluetooth™ device, an 802.11 device, a WiFi device, a WiMax device, a WWAN device, a Z-Wave device, a ZigBee device, cellular communication facilities, etc.), and/or a LP wireless device. The communications subsystem 530 may permit data to be exchanged with a network (such as the network described below, to name one example), with other computer or hardware systems, between data centers or different cloud platforms, and/or with any other devices described herein. In many embodiments, the computer system 500 further comprises a working memory 535, which can include a RAM or ROM device, as described above.

The computer system 500 also may comprise software elements, shown as being currently located within the working memory 535, including an operating system 540, device drivers, executable libraries, and/or other code, such as one or more application programs 545, which may comprise computer programs provided by various embodiments (including, without limitation, various applications running on the various servers and/or controllers as described above), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) included in the working memory 535, or alternatively in graphics memory 555. Such instructions may be read into the working memory 535 from another computer readable medium, such as one or more of the storage device(s) 525. Merely by way of example, execution of the sequences of instructions included in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally receives the signals, and the bus 505 then might carry the signals (and/or the data, instructions, etc. carried by the signals) to the working memory 535, from which the processor(s) 510 retrieves and executes the instructions. The instructions received by the working memory 535 and/or graphics memory 555 may optionally be stored on a storage device 525 either before or after execution by the processor(s) 510 and/or the graphics processing unit 550.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to certain structural and/or functional components for ease of description, methods provided by various embodiments are not limited to any single structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in sequentially for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a specific structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to one embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A system comprising:
a graphics processing unit (GPU);
graphics memory coupled to the graphics processing unit;
a processor; and
non-transitory computer readable media comprising instructions executable by the processor to:
define, via an asset file, one or more shader functions of a GPU programming language in source code written in a central processing unit (CPU) programming language;
extend a first programming language to include the one or more shader functions defined in the asset file;
instantiate the first programming language, in a code editor, based on the one or more asset files, wherein the first programming language includes the CPU programming language and the one or more shader functions;
receive, via an interface of the code editor, code written in the first programming language for a first program;
generate, via the code editor, one or more GPU source code files of the first program in one or more respective GPU programming languages, the first program comprising at least one of CPU programming language enumeration, constants, structs, fields, and methods, wherein the one or more GPU source code files includes constants and defines, automatically generated by a code generator of the code editor, corresponding to the at least one of CPU programming language enumeration, constants, structs, fields, and methods; and
generate, via the code editor, a GPU executable binary of the first program.

2. (canceled)

3. The system of claim 1, wherein the instructions are further executable by the processor to:
transmit the GPU executable binary to the graphics memory; and
cause the GPU executable binary to be executed by the GPU.

4. The system of claim 1, wherein the instructions are further executable by the processor to:
modify the asset file to define one or more additional shader functions in the CPU programming language.

5. The system of claim 1, wherein the instructions are further executable by the processor to:
parse one or more shader functions of the code for the first program into the CPU executable programming language;
generate one or more CPU executable instructions corresponding to the one or more shader functions based on the CPU executable programming language; and
debug, based on the CPU executable instructions, the code for the first program by executing at least part of the first program on the processor.

6. The system of claim 1, wherein the instructions are further executable by the processor to:
cause, via the code editor, a CPU code debugger to debug at least part of a first program written in the first programming language.

7. The system of claim 6, wherein the instructions are further executable by the processor to:
simulate, via the code editor, dispatch of at least part of a GPU kernel on the processor, wherein the at least part of the first program includes the at least part of the GPU kernel; and
execute at least one thread of at least one group thread of at least one dispatch thread for each kernel function of the at least part of the GPU kernel.

8. An apparatus comprising:
a processor;
non-transitory computer readable media comprising instructions executable by the processor to:
define, via an asset file, one or more shader functions of a GPU programming language in source code written in a central processing unit (CPU) programming language;
extend a first programming language to include the one or more shader functions defined in the asset file;
instantiate the first programming language, in a code editor, based on the one or more asset files, wherein the first programming language includes the CPU programming language and the one or more shader functions;
receive, via an interface of the code editor, code written in the first programming language for a first program;
generate, via the code editor, one or more GPU source code files of the first program in one or more respective GPU programming languages, the first program comprising at least one of CPU programming language enumeration, constants, structs, fields, and methods, wherein the one or more GPU source code files includes constants and defines, automatically generated by a code generator of the code editor, corresponding to the at least one of CPU programming language enumeration, constants, structs, fields, and methods; and
generate, via the code editor, a GPU executable binary of the first program.

9. (canceled)

10. The apparatus of claim 8, wherein the instructions are further executable by the processor to:
transmit the GPU executable binary to the graphics memory; and
cause the GPU executable binary to be executed by the GPU.

11. The apparatus of claim 8, wherein the instructions are further executable by the processor to:
modify the asset file to define one or more additional shader functions in the CPU programming language.

12. The apparatus of claim 8, wherein the instructions are further executable by the processor to:
parse one or more shader functions of the code for the first program into the CPU executable programming language;
generate one or more CPU executable instructions corresponding to the one or more shader functions based on the CPU executable programming language; and
debug, based on the CPU executable instructions, the code for the first program by executing at least part of the first program on the processor.

13. The apparatus of claim 8, wherein the instructions are further executable by the processor to:
allow, via the code editor, a CPU code debugger to debug at least part of a first program written in the first programming language.

14. The apparatus of claim 8, wherein the instructions are further executable by the processor to:
simulate, via the code editor, dispatch of at least part of a GPU kernel on the processor, wherein the at least part of the first program includes the at least part of the GPU kernel; and
execute at least one thread of at least one group thread of at least one dispatch thread for each kernel function of the at least part of the GPU kernel.

15. A method comprising:
defining, via an asset file, one or more shader functions of a GPU programming language in source code written in a central processing unit (CPU) programming language;
extending, via a computer system, a first programming language to include the one or more shader functions defined in the asset file;
instantiating, via the computer system, the first programming language based on the one or more asset files, wherein the first programming language includes the CPU programming language and the one or more shader functions;
receiving, via the computer system, code written in the first programming language for a first program;
generating, via the computer system, one or more GPU source code files of the first program in one or more respective GPU programming languages, the first program comprising at least one of CPU programming language enumeration, constants, structs, fields, and methods, wherein the one or more GPU source code files includes constants and defines, automatically generated by a code generator of the code editor, corresponding to the at least one of CPU programming language enumeration, constants, structs, fields, and methods; and
generating, via the computer system, a GPU executable binary of the first program.

16. (canceled)

17. The method of claim 15, further comprising:
transmitting, via a processor, the GPU executable binary to the graphics memory; and
causing, via the processor, the GPU executable binary to be executed by the GPU.

18. The method of claim 15, further comprising:
modifying, via the computer system, the asset file to define one or more additional shader functions in the CPU programming language.

19. The method of claim 15, further comprising:
parsing, via the computer system, one or more shader functions of the code for the first program into the CPU executable programming language;
generating, via the computer system, one or more CPU executable instructions corresponding to the one or more shader functions based on the CPU executable programming language; and
debugging, via the computer system, based on the CPU executable instructions, the code for the first program by executing at least part of the first program on the processor.

20. The method of claim 15, further comprising:
simulating, via a CPU, dispatch of at least part of a GPU kernel on the processor, wherein the at least part of the first program includes the at least part of the GPU kernel; and
executing, with the CPU, at least one thread of at least one group thread of at least one dispatch thread for each kernel function of the at least part of the GPU kernel.
